(19) United States
(12) Patent Application Publication
(10) Pub. No.: US 2011/0309063 A1
(43) Pub. Date: Dec. 22, 2011

(54) WELDING WIRE FEEDER WITH MAGNETIC ROTATIONAL SPEED SENSOR

(75) Inventors: Brian Lee Ott, Sherwood, WI (US); Jeremy Daniel Overesch, Neenah, WI (US)

(73) Assignee: lllinois Tool Works Inc., Glenview, IL (US)

(21) Appl. No.: 13/158,005

(22) Filed: Jun. 10, 2011

Related U.S. Application Data
(60) Provisional application No. 61/355,815, filed on Jun. 17, 2010.

(51) Int. Cl. B23K 9/10

(52) U.S. Cl. 219/137.71

(57) ABSTRACT

A welding wire feeder includes a magnetic rotational sensor system configured to measure a parameter indicative of a wire feed speed of the welding wire feeder. The magnetic rotational sensor system includes a dipole magnet coupled to a gear driven by an electric motor of the welding wire feeder and a magnetic sensor disposed adjacent to the dipole magnet and configured to measure an angular position of the dipole magnet. The magnetic rotational sensor system also includes a processor configured to receive signals of the angular position measured by the magnetic sensor and to calculate a wire feed speed of the welding wire feeder based upon the angular position signals and configuration parameters of the welding wire feeder.

### CROSS REFERENCE TO RELATED APPLICATIONS

This application is a Non-Provisional Patent Application of U.S. Provisional Patent Application No. 61/355,815 entitled “Magnetic Rotational Speed Sensor in a Welding Wirefeeder”, filed Jun. 17, 2010, which is herein incorporated by reference.

### BACKGROUND

The invention relates generally to welding systems, and, more particularly, to a welding wire feeder with a magnetic rotational speed sensor.

Welding is a process that has become increasingly ubiquitous in various industries and applications. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure the appropriate advance of welding wire to a welding torch, with the wire establishing the welding arc and being consumed as welding progresses.

In MIG systems, wire feeding operating parameters for a given welding application may vary depending on a variety of factors such as the type of wire used, the size of the wire spool, the physical characteristics of the wire, the length and type of torch and torch cable, the temperature of the welding process, the type of welding process, and so forth. Frequently, such wire feeding operating parameters may be monitored during a welding operation. For example, a wire feed speed of a welding wire feeder may be measured using programmed motor characterization or resistance and voltage slopes. Unfortunately, programmed motor characterization and resistance and voltage slope methods may provide imprecise measurements and data. Alternatively, optical tachometers, e.g., light emitting diodes (LEDs) and encoder wheels, may be used to measure wire feed speed. However, optical tachometers, which may be mounted to a motor shaft of the wire feeder motor, are prone to failure in high temperature environments. Additionally, dust or contaminants in a welding environment may block the light path of the LEDs, further reducing the effectiveness of the optical tachometer. Furthermore, the optical tachometer may be tightly coupled to the motor drive of the wire feeder which, while potentially providing higher resolutions, may increase the difficulty of removing or replacing the motor.

### BRIEF DESCRIPTION

In an exemplary embodiment, a welding wire feeder system includes a wire drive configured to contact a welding wire and to drive the welding wire towards a welding application, a gear assembly coupled to the wire drive and configured to force rotation of the wire drive during operation, and an electric motor assembly coupled to the gear assembly and configured to force rotation of the gear assembly during operation. The welding wire feeder system also includes a magnetic rotational sensor system configured to measure a parameter indicative of a wire feed speed of the welding wire feeder system.

In another exemplary embodiment, a wire feed speed sensor system includes a dipole magnet coupled to a gear driven by an electric motor of a welding wire feeder, a magnetic sensor disposed adjacent to the dipole magnet and configured to measure an angular position of the dipole magnet, and a processor configured to receive signals of the angular position measured by the magnetic sensor and to calculate a wire feed speed of a welding wire feeder based upon the angular position signals and configuration parameters of the welding wire feeder.

In a further embodiment, a method for measuring wire feed speed of a welding wire feeder includes measuring an angular position of a gear driven by an electric motor configured to drive a welding wire to a welding application, sampling the angular position at a desired interval, and calculating the wire feed speed based upon the angular position of the gear and configuration parameters of the welding wire feeder.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary welding system;

FIG. 2 is a diagrammatical illustration of exemplary functional components of the welding wire feeder system of FIG. 1;

FIG. 3 is a diagrammatical representation of a magnetic wire feed speed sensor configured to measure a wire feed speed of the welding wire feeder system of FIG. 1;

FIG. 4 is a graphical representation of angular velocity of a gear of the welding wire feeder system versus a voltage applied to the electric motor of the system; and

FIG. 5 is a flow chart illustrating an exemplary method of determining a wire feed speed using the magnetic wire feed speed sensor of FIG. 3.

### DETAILED DESCRIPTION

The present disclosure describes exemplary embodiments of a welding wire feeder having a magnetic wire feed speed sensor. The welding wire feeder includes a motor configured to drive a roll to feed a welding wire to a welding torch. The motor further drives an idler gear, the rotation of which is measured by the magnetic wire feed speed sensor by calculating an angular position and velocity of the idler gear. Rotation of another gear or rotating component of the system could be similarly measured. More specifically, in the embodiment described, the angular position and velocity are measured using a magnet disposed on a shaft coupled the idler gear and positioned over an integrated circuit to sample the angular position of the shaft at a regular interval. The angular position data is then used to determine the angular velocity of the idler gear, which can be further converted into a wire feed speed measurement.

As will be appreciated, the magnetic wire feed speed sensor may be used with a variety of welding wire feeder motors, welding wires, and gear ratios. Additionally, the magnetic wire feed speed sensor provides a non-contact form of position/speed sensing that can provide an enhanced data resolution, and may be coupled a motor drive casting rather than the motor drive itself, thereby enabling more streamlined motor drive removal and replacement. Furthermore, as the magnetic wire feed speed sensor measures a magnetic field to determine a wire feed speed, dust and other contaminants in a welding environment are less likely to interfere with data collection by the wire feed speed sensor.

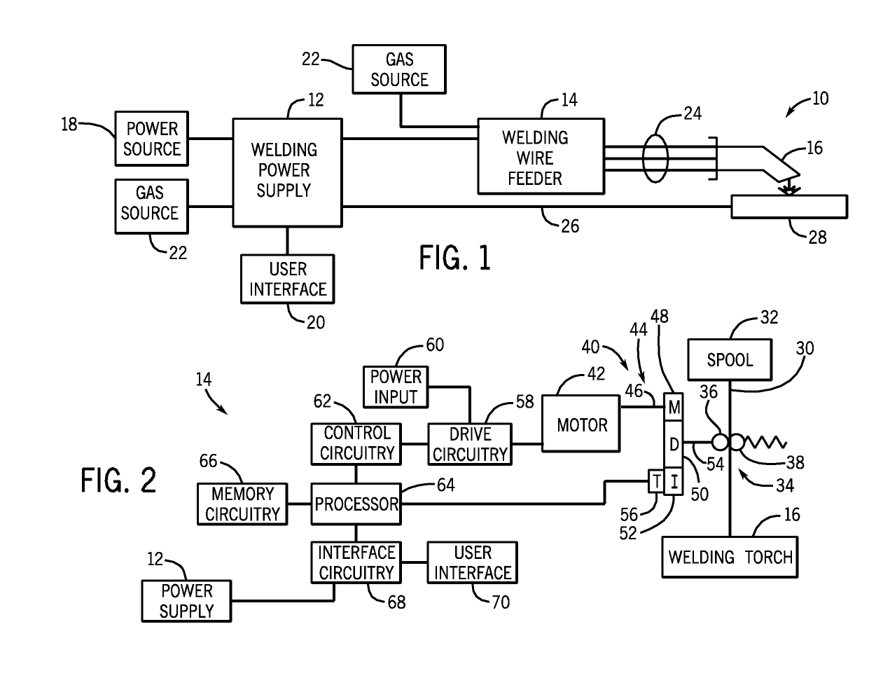

Turning now to the drawings, FIG. 1 illustrates an exemplary welding system 10 which powers, controls, and provides supplies to a welding operation. The welding system 10 includes a welding power supply 12, a wire feeder 14, and a welding torch 16. The power supply 12 may be a power converter style welding power supply or an inverter welding power supply requiring a power source 18. In other embodiments, the welding power supply 12 may include a generator or alternator driven by an internal combustion engine. The welding power supply 12 may also include a user interface 20 for inputting or adjusting various operating parameters of the welding power supply 12, such as voltage and current. In some embodiments, the user interface 20 may further be configured to input or adjust various operating parameters of the welding wire feeder 14, such as welding wire diameter, wire feed speed, and so forth. As shown, the welding power supply 12 is coupled to the welding wire feeder 14. As will be appreciated, the welding power supply 12 may be couple to the welding wire feeder 14 by a feeder power lead, a weld cable, and a control cable.

The welding wire feeder 14 in the illustrated embodiment provides welding wire to the welding torch 16 for use in the welding operation. Specifically, the welding wire feeder 14 feeds welding wire from a spool to the welding torch 16. A variety of welding wires may be used. For example, the welding wire may be solid (e.g., carbon steel, aluminum, stainless steel), composite, flux cored, and so forth. Furthermore, the thickness of the welding wire may vary depending on the welding application for which the welding wire is used. For example, the welding wire may be 0.045″, 0.052″, 1/16″ or 5/64″. The welding wire feeder 14 may enclose a variety of internal components such as a wire feed drive system, an electric motor assembly, an electric motor, and so forth. Additionally, a gas source 22 may be coupled to the welding wire feeder 14. The gas source 22 is the source of the gas that is supplied to the welding torch 16. As discussed in detail below, the welding wire feeder 14 may further include a magnetic feed speed sensor configured to measure a feed speed of the wire supplied by the feeder 14. Additionally, the magnetic wire feed speed sensor may be a non-contact sensor configured to operate with any one of a plurality of motors that may be used in the welding wire feeder 14. In other words, the magnetic wire feed speed sensor may be disposed within the welding wire feeder 14 independently of the motor, thereby enabling independent removal and replacement of the motor, without removing or replacing the magnetic wire feed speed sensor.

As shown, the welding wire supplied by the welding wire feeder 14 is fed to the welding torch 16 through a first cable 24. The first cable 24 may also supply gas to the welding torch 16. As further shown, a second cable 26 couples the welding power supply 12 to a work piece 28 (typically via a clamp) to complete the circuit between the welding power supply 12 and the welding torch 16 during a welding operation.

It should be noted that modifications to the exemplary welding system 10 of FIG. 1 may be made in accordance with aspects of the present invention. For example, the welding wire feeder 14 may further include a user interface to enable a user to input and adjust various wire feed settings or operating parameters of the welding wire feeder 14, such as wire feed speed, welding wire diameter, and so forth. Furthermore, although the illustrated embodiments are described in the context of a metal inert gas (MIG) welding process, the features of the invention may be utilized with a variety of welding processes.

FIG. 2 is a block diagram illustrating certain of the internal components of the welding wire feeder 14. As discussed above, a welding wire 30 is fed from a welding wire spool 32 by a wire drive 34, and therefrom to the welding torch 16. In the illustrated embodiment, the wire drive 34 includes a drive roll 36 and a biasing roll 38. As shown, biasing roll 38 is biased towards the welding wire 30, and the drive roll 36 is mechanically coupled to an electric motor assembly 40 having an electric motor 42. As will be appreciated, the drive roll 36 is rotated by the electric motor assembly 40 to drive the welding wire 30, while the biasing roll 38 is biased towards the welding wire 30 to maintain good contact between the biasing roll 38, the drive roll 36 and the welding wire 30. In other embodiments, the wire drive 34 may include multiple rollers of this type. Various physical configurations of rollers, biasing assemblies and motor mounts and assemblies may be used, and the invention is not intended to be limited to any particular arrangement of these.

As mentioned above, the welding wire feeder 14 includes the electric motor assembly 40 which may employ any one of a plurality of available electric motors, gear combinations, and so forth, depending upon the drive scheme (e.g., input signal type), the type of motor desired (e.g., DC, torque, etc.), the anticipated wire size and torque requirements, and the anticipated speed range. In addition to an electric motor 42, which in a presently contemplated embodiment is a brushed DC motor, the electric motor assembly 40 includes a gear assembly 44. Specifically, a motor shaft 46 driven by the electric motor 42 is coupled to a motor gear 48. The motor gear 48 is mechanically coupled to a drive roll gear 50. The drive roll gear 50 is coupled to a drive shaft 54, which is coupled to the drive roll 36. Therefore, as the electric motor 42 drives the motor shaft 46 into rotation, the motor gear 48 will transfer power to the drive roll gear 50, which will drive the rotation of the drive roll 36. As the drive roll 36 is driven into rotation, the welding wire 30 will be fed to the welding torch 16 by the welding wire feeder 14. The motor gear 48 and the drive roll gear 50 may have a variety of different gear ratios. For example, the motor gear 48 and the drive roll gear 50 may have a first gear ratio configured to provide a standard wire feed speed and a standard torque. Alternatively, the motor gear 48 and the drive roll gear 50 may have a second gear ratio configured to provide a low wire feed speed and a high torque. As mentioned above, the welding wire feeder 14 includes a magnetic wire feed speed sensor 56. Specifically, in the illustrated embodiment, the magnetic wire feed speed sensor 56 is coupled to an idler gear 52, which is further mechanically coupled to the drive roll gear 50. As described in detail below, the magnetic wire feed speed sensor 56 is configured to measure and provide the user with an indication of the rotational speed of the electric motor or the wire feed speed, and may be used for closed-loop control of the wire drive speed. As the idler gear 52 is driven into rotation by the drive roll gear 50, the magnetic wire feed speed sensor 56, using a magnet and a magnetic sensor, samples the angle or position of the idler gear 52 at a desired interval, typically fixed. The angle or position data collected by the magnetic wire feed speed sensor 56 is then used to determine the wire feed speed of the welding wire 30, in the manner described below. As with the motor gear 48 and the drive roll gear 50, the drive roll gear 50 and the idler gear 52 may have a variety of gear ratios. Furthermore, because the magnetic wire feed speed sensor 56 and the idler gear 52 are not directly coupled to the electric motor 42, the motor shaft 46, or the motor gear 48, such parts may be removed and replaced in the welding wire feeder 14 without requiring that the magnetic wire feed speed sensor 56, the drive roll gear 50, or the idler gear 52 be removed or replaced.

The welding wire feeder 14 includes drive circuitry 58 coupled to the electric motor assembly 40. In one embodiment, the drive circuitry 58 may be coupled to the electric motor assembly 40 by two leads (not shown). The drive circuitry 58 is configured to apply drive signals to the electric motor assembly 40 in operation. The drive circuitry 58 further includes a power input 60 to provide power to the drive circuitry 58. The drive circuitry is further electrically coupled to control circuitry 62. The control circuitry 62 is configured to apply control signals to the drive circuitry 58. For example, the control circuitry 62 may provide pulse width modulated (PWM) signals to the drive circuitry 58 to regulate a duty cycle of drive signals from the drive circuitry 58 to the electric motor assembly 40. For example, the control circuitry 62 may send PWM signals to the drive circuitry 58 to achieve a duty cycle of 100%, 50%, 25%, or at any desired level for the drive signals applied to the electric motor assembly 40. In certain embodiments, control signals for regulating the wire feed speed (and hence the motor speed) may originate in the welding power supply.

As shown in the illustrated embodiment, the control circuitry 62 is coupled to a processor 64, memory circuitry 66 and interface circuitry 68. The magnetic wire feed speed sensor 56 is also coupled to the processor 64. As mentioned above, the magnetic wire feed speed sensor 56 samples the angle or position of the idler gear 52 at a desired interval. The angle measurements of the idler gear 52 collected by the magnetic wire feed speed sensor 56 are monitored by the processor 64 over time. Furthermore, using the measurements, the processor 64 calculates the rotational distance traveled by the idler gear 52 and, subsequently, the rotational velocity of the idler gear 52. Using the rotational velocity of the idler gear 52, the wire feed speed of the welding wire feeder 14 is determined.

The wire feed speed calculated by the processor 64 may be displayed on a user interface 70 of the welding wire feeder 14. Specifically, the wire feed speed calculated by the processor 64 may be communicated to the interface circuitry 68, which is coupled to the user interface 70, and the interface circuitry 68 may be communicate the wire feed speed to the user interface 70. The user interface 70 may also enable an operator to input and adjust various settings and operating parameters of the welding wire feeder 14. For example, in certain embodiments, the user interface 70 may be used to select or adjust the wire feed speed of the welding wire feeder 14.

Additionally, in some configurations, the interface circuitry 68 may be coupled to the welding power supply 12. In such configurations, the welding power supply 12 may be allowed to exchange signals with the welding wire feeder 14. For example, multi-pin interfaces may be provided on the welding power supply 12 and the welding wire feeder 14, and a multi-conductor cable may be run between the power supply 12 and the wire feeder 14 to allow for such information as wire feed speeds, processes, selected currents, voltages, power levels or configuration parameters, and so forth to be set on either the power supply 12, the wire feeder 14, or both. Furthermore, the welding power supply 12 may provide feedback pertaining to the welding operation to the user through the user interface 70 of the welding wire feeder 14.

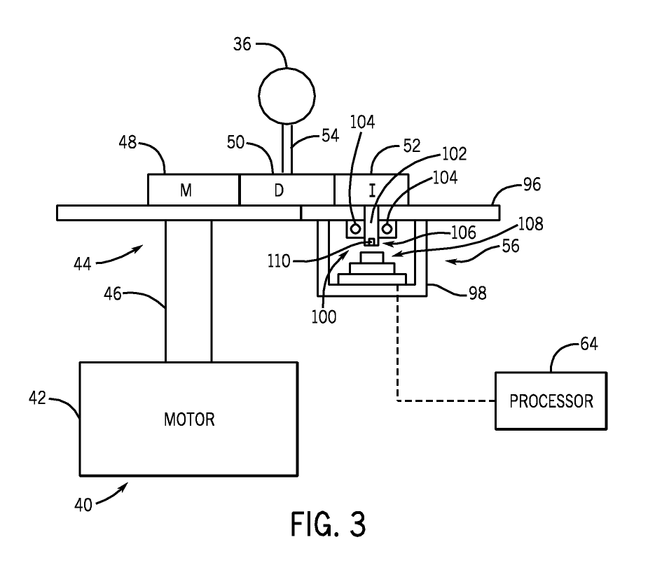

FIG. 3 illustrates the magnetic wire feed speed sensor 56 configured to measure a wire feed speed of the welding wire feeder 14 of FIG. 1. As discussed above, the welding wire feeder 14 includes the electric motor assembly 40 having the electric motor 42 configured to drive the gear assembly 44. Specifically, the electric motor 42 drives the motor shaft 46 that extends through a mounting plate 96, which may be a motor drive casting or other surface, and is coupled to the motor gear 48. As the motor gear 48 is driven, the motor gear 48 drives the drive roll gear 50, which further drives the idler gear 52. In the illustrated embodiment, the idler gear 52 is disposed adjacent to the mounting plate 96, and the magnetic wire feed speed sensor 56 is coupled to the mounting plate 96 on a side of the mounting plate 96 opposite the idler gear 52. The magnetic wire feed speed sensor 56 includes a module box 98 that is coupled to the mounting plate 96 and defines a cavity 100 between the module box 98 and the mounting plate 96.

As shown, the idler gear 52 is coupled to an idler shaft 102 that extends through the mounting plate 96 and into a cavity 100 of the magnetic wire feed speed sensor 56. Bearings 104 are disposed on either side of the idler shaft 102 to provide constrained rotation of the idler shaft 102 within the module box 98. The idler shaft 102 is partially disposed within the cavity 100 such that an end 106 of the idler shaft 102 is disposed over a magnetic sensor 108 disposed within the module box 98. Further, the end 106 of the idler shaft 102 includes a magnet 110. For example, the magnet 110 may be a standard dipole magnet. The idler shaft 102 is coupled to the idler gear 52 and disposed over the magnetic sensor 108 such that the distance between the magnet 110 and the magnetic sensor 108 is constant. As the idler gear 52 is driven into rotation by the drive roll gear 50, the idler shaft 102 and the magnet 110 also rotate above the magnetic sensor 108. The magnetic sensor 108 includes an integrated circuit configured to detect a slope of the magnetic field generated by the magnet 110 to determine an angular position of the idler shaft 52. For example, the magnetic sensor 108 may be the AS5040 Rotary Encoder IC manufactured by Austria Microsystems.

The magnetic sensor 108 is coupled to the processor 64, which monitors the angular position of the idler shaft 102 measured by the magnetic sensor 108. Specifically, as the idler gear 52 is driven by the drive roll gear 50, thereby rotating the idler shaft 102 and the magnet 110, the processor 64 samples the angle or position of the idler shaft 52 using the magnetic sensor 108 and stores the angular position measurement and the time the angular position measurement was taken. For example, the angular position and time data may be stored in the memory circuitry 66. Using the angular position and time measurements, the processor 64 calculates an angular velocity of the idler shaft 102. For example, the angular velocity may be calculated by finding a difference between two angular positions and dividing the difference by the time interval between the angular position samples. Various intervals may be used, and, where desired, low pass filtering, moving averages and similar techniques may be employed to smooth the calculated values and reduce noise. Based on the angular velocity, and other factors such as gear ratios of the drive roll gear 50, idler gear 52, drive roll 36 diameter, welding wire 30 size, and so forth, the wire feed speed is calculated. These will typically be used to scale the angular velocity calculated to the wire feed speed through the one or more gear ratios applied. As described below, the angular velocity of the idler shaft 102 calculated by the processor 64 is associated or matched with the corresponding voltage supplied to electric motor 42 to generate the calculated angular velocity of the idler shaft 102. Based on the relationship between the voltage supplied to the electric motor 42 and the corresponding angular velocity of the idler shaft 102, the resulting wire feed speed may be adjusted.

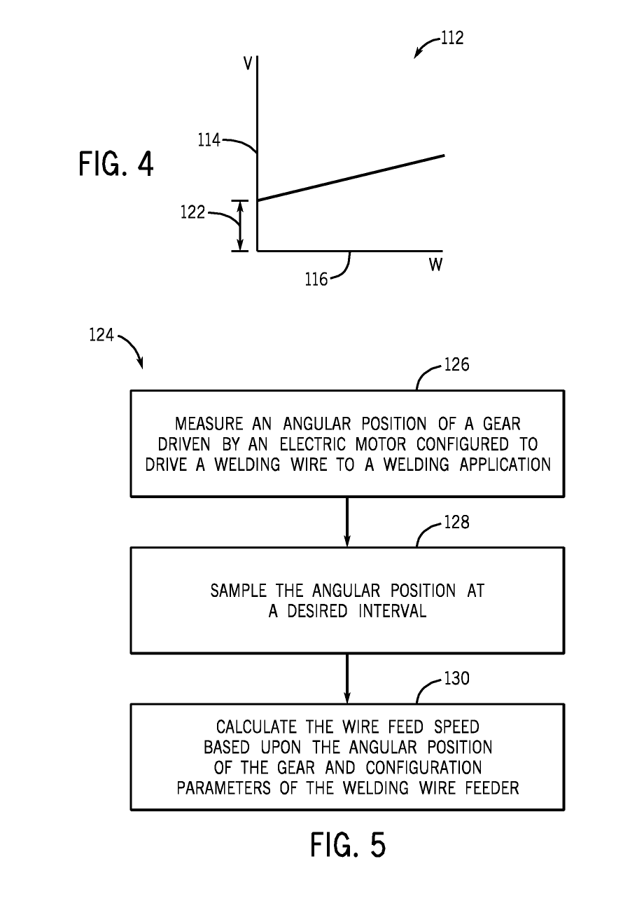

FIG. 4 illustrates a graph 112 of the relationship between a voltage 114 applied to the electric motor 42 and a resulting angular velocity 116 of the idler shaft 102. As mentioned above, a user may increase the wire feed speed of the welding wire feeder 14 using user interface 70. For example, when the user interface 70 receives a command to increase the wire feed speed, the user interface 70 may communicate the command to the interface circuitry 68, which may communicate the command to the processor 64. The processor 64 may then provide the command to the control circuitry 62 which provides control signals to the drive circuitry 58. In response to the command to increase the wire feed speed, the drive circuitry 58 increases the voltage 114 applied to the electric motor 42. As the voltage 114 applied is increased, the angular velocity 116 of the idler shaft 102 will increase. Similarly, as the voltage 114 applied to the electric motor 42 is decreased, the angular velocity 116 of the idler shaft 102 will decrease.

As shown by the graph 112, in the contemplated case, a linear relationship exists between the voltage 114 applied to the electric motor 42 and the resulting angular velocity 116 of the idler shaft 102. In other words, as the voltage 114 applied to the electric motor 42 is increased, the resulting angular velocity 116 of the increases proportionally. Additionally, a startup voltage 122 is required to initiate operation of the electric motor 42. In other words, upon the application of the startup voltage 122 to the electric motor 42, the angular velocity of the idler shaft 102 is not increased.

FIG. 5 is a flow chart 124 illustrating an exemplary method for measuring a wire feed speed of the welding wire feeder 14 using a magnetic wire feed speed sensor 56. First, as represented by block 126, an angular position of a gear driven by an electric motor 42 configured to drive a welding wire 30 to a welding application is measured. As discussed in detail above, the gear may be an idler gear 52. Additionally, the angular position of the gear may be measured by detecting the magnetic field created by a dipole magnet 110 coupled to the gear. In certain embodiments, the dipole magnet 110 may be coupled to an idler shaft 102 of the idler gear 52. The magnetic field is measured by a magnetic sensor 108 disposed adjacent to, but not in contact with, the dipole magnet 110. As represented by block 128, the angular position of the gear is sampled at a desired interval. For example, a processor 64 may be coupled to the magnetic sensor 108 (or through intermediate sampling, conversion, or other circuitry) and be configured to monitor the angular position measured by the magnetic sensor 108. More specifically, the processor 64 may monitor the angular position of the gear and the time when the angular position measurement is taken. As represented by block 130, a wire feed speed of the welding wire 30 is calculated based upon the angular position of the gear and configuration parameters of the welding wire feeder 14. For example, configuration parameters of the welding wire feeder 14 may include a gear ratio of the gear assembly 44 in the welding wire feeder 14, a diameter of the welding wire 30, a diameter of a drive roll 36 in the welding wire feeder 14, and so forth. Again, the calculation may be based upon a difference in measured positions, divided by a time interval between the measurements. Filtering (e.g., averaging, low pass filtering, etc.) may be used to smooth the calculated values. The various gear rations, then, are used to arrive at a wire feed speed value.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding wire feeder system comprising:
a wire drive configured to contact a welding wire and to drive the welding wire towards a welding application;
a gear assembly coupled to the wire drive and configured to force rotation of the wire drive during operation;
an electric motor assembly coupled to the gear assembly and configured to force rotation of the gear assembly during operation; and
a magnetic rotational sensor system configured to measure a parameter indicative of a wire feed speed of the welding wire feeder system.

2. The system of claim 1, wherein the magnetic rotational sensor system comprises a dipole magnet, a magnetic sensor, and a processor.

3. The system of claim 2, wherein the gear assembly comprises a motor gear, a drive roll gear, and an idler gear, the dipole magnet is coupled to the idler gear, and the magnetic sensor is configured to measure an angular position of the idler gear.

4. The system of claim 3, wherein the processor is configured to process measurements of the angular position of the idler gear sampled at a fixed sampling interval.

5. The system of claim 4, wherein the processor is configured to calculate the wire feed speed of the welding wire feeder system based upon the angular position of the idler gear and configuration parameters of the welding wire feeder system.

6. The system of claim 5, wherein the configuration parameters comprise a gear ratio of the motor gear, the drive roll gear, and the idler gear, the diameter of a drive roll of the wire drive, or a diameter of the welding wire.

7. The system of claim 4, wherein the fixed sampling interval is based upon a gear ratio of the drive roll gear and the idler gear.

8. The system of claim 2, wherein the magnetic sensor is coupled to a mounting plate assembled independently of the electric motor assembly.

9. The system of claim 1, comprising control circuitry coupled to the electric motor assembly and a user interface configured to allow for user adjustment of the wire feed speed coupled to the control circuitry.

10. A wire feed speed sensor system comprising:
a dipole magnet coupled to a gear driven by an electric motor of a welding wire feeder;
a magnetic sensor disposed adjacent to the dipole magnet and configured to measure an angular position of the dipole magnet; and
a processor configured to receive signals of the angular position measured by the magnetic sensor and to calculate a wire feed speed of a welding wire feeder based upon the angular position signals and configuration parameters of the welding wire feeder.

11. The system of claim 10, wherein the magnetic sensor and the processor are mounted to the welding wire feeder independent from the electric motor.

12. The wire feed speed sensor system of claim 10, wherein the configuration parameters comprise a gear ratio of the gear, a diameter of a welding wire driven by the welding wire feeder, or a diameter of a drive roll of the welding wire feeder.

13. The system of claim 10, wherein the magnetic sensor comprises an integrated circuit configured to measure a slope of the magnetic field generated by the dipole magnet to determine the angular position of the dipole magnet.

14. The system of claim 10, wherein the processor is configured to receive the signals of the angular position measured by the magnetic sensor at a fixed sampling interval.

15. The system of claim 10, wherein the dipole magnet is disposed on the end of a shaft coupled to the gear.

16. A method for measuring wire feed speed of a welding wire feeder, comprising:
measuring an angular position of a gear driven by an electric motor configured to drive a welding wire to a welding application;
sampling the angular position at a desired sampling interval;
calculating the wire feed speed based upon the angular position of the gear and configuration parameters of the welding wire feeder.

17. The method of claim 16, wherein calculating the wire feed speed based upon the angular position of the gear and configuration parameters of the welding wire feeder comprises calculating an angular velocity of the gear.

18. The method of claim 16, wherein the configuration parameters comprise a gear ratio of the gear, a diameter of the welding wire, or a diameter of a drive roll of the welding wire feeder.

19. The method of claim 16, comprising regulating control signals applied to the electric motor based upon the wire feed speed calculated.

20. The method of claim 16, wherein the desired sampling interval is based upon configuration parameters of the welding wire feeder.
